(19) United States
(12) Patent Application Publication
(10) Pub. No.: US 2003/0179068 A1
(43) Pub. Date: Sep. 25, 2003

(54) Circuit breaker

(76) Inventor: Tsunoru Higashi, Yokohama-shi (JP)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/335,768

(22) Filed: Jan. 2, 2003

(30) Foreign Application Priority Data
Mar. 19, 2002 (JP) 2002-075553
Jul. 2, 2002 (JP) 2002-193183

(51) Int. Cl. H01H 61/01

(52) U.S. Cl. 337/85; 337/36

(57) ABSTRACT

A reusable miniature circuit breaker including a fixed contact and a mobile contact carried by a bimetal type arm usually kept in osculation with the fixed contact, both being accommodated in a cylindrical casing in connection with a circuit of electric or electronic devices. On generation of overcurrent, the bimetal type arm exhibits thermal deformation to drive the contacts out of osculation, thereby intercepting the circuit and, on disappearance of the overcurrent, resumes the original configuration to restore osculation of the contacts.

### BACKGROUND OF THE INVENTION

The present invention relates to a circuit breaker, and more particularly relates to a miniature and reusable circuit breaker well suited for incorporation into electric and electronic devices.

In operation of an electric circuit, accidental generation of overcurrent sometimes occurs due to various reasons. When the operation of the circuit continues under such overcurrent conditions, heat generated by circuit elements tends to cause accidental fire or damage electric or electronic devices connected to the circuit. In order to avoid such troubles, it is generally employed to interpose one or more circuit breakers in a circuit so as to automatically intercept the circuit at accidental generation of overcurrent.

A typical conventional circuit breaker (sometimes called “a glass tube fuse”) includes two metallic elements on both terminals of a cylindrical casing and connected by a thin metallic fuse. Once the fuse intercepts the circuit via burning due to heat caused by overcurrent generation, the whole circuit breaker needs to be replaced. This is quite disadvantageous from the viewpoint of economy and saving of resources and cumbersome in maintenance operation.

### SUMMARY OF THE INVENTION

It is thus the primary object of the present invention to provide a reusable miniature circuit breaker which assures repeated use without replacement after generation of overcurrent.

The basic concept of the present invention depends on use of a bimetal type arm arranged within a hollow cylindrical casing. The bimetal type arm carries a mobile contact opposite to a fixed contact, both contacts being connected to respective circuit sections connected to a power source and electric or electronic devices respectively. Under normal current conditions, the contacts are kept in osculation. On generation of overcurrent, resultant thermal deformation of the bimetal type arm drives the contacts out of the osculation to intercept the circuit. As the over current disappears, the bimetal type arm resumes its original configuration to restore the osculation of the contacts.

### BRIEF DESCRIPTION OF THE DRAWINGS

FIG. 1 is a cross-sectional side view of one embodiment of the circuit breaker in accordance with the present invention,

FIG. 2 is a cross-sectional side view of a modification of the circuit breaker shown in FIG. 1,

FIG. 3 is a perspective view, partly omitted, of another embodiment of the circuit breaker in accordance with the present invention, and

FIG. 4 is its cross-sectional side view.

### DESCRIPTION OF THE REFERRED EMBODIMENTS

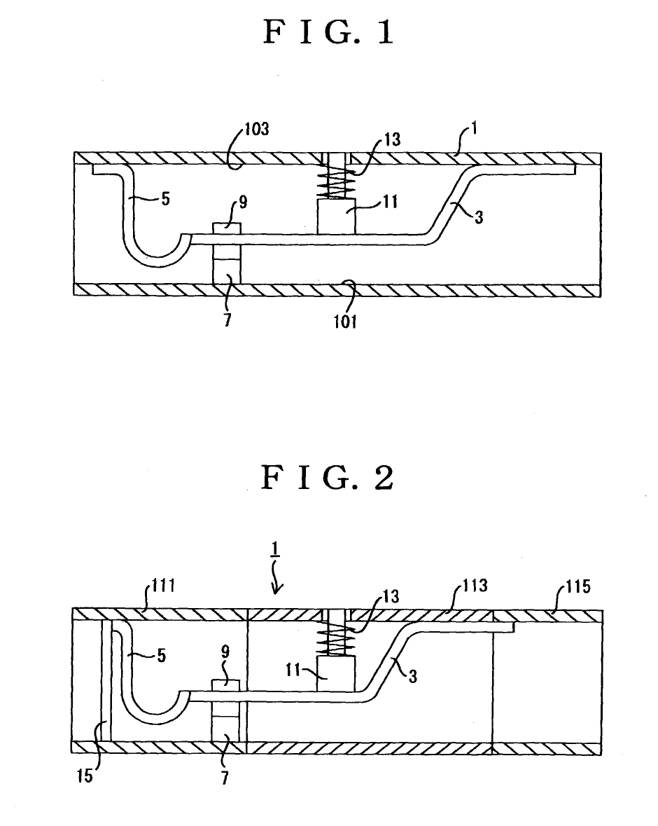

One embodiment of the circuit breaker in accordance with the present invention is shown in FIG. 1, in which a monolithic, hollow, cylindrical casing 1 is used. Near one longitudinal end of the casing 1 is arranged a fixed contact 7 on one inner wall 101 of the casing 1 in connection with a first circuit section not shown. A bimetal arm 3 is attached at its proximal end on the other inner wall 103 of the casing 1. When the casing 1 has a circular cross section, the one and the other inner walls 101, 103 are in a continuous cylindrical plane.

In the case of the illustrated embodiment, the bimetal arm 3 is bent toward the one inner wall 101 of the casing 1 at a section somewhat distant from its proximal end and carries at its distal end a mobile contact 9 at a position opposite the fixed contact 7. The mobile contact 9 is connected to a second circuit section not shown.

The first and second circuit sections form an electric circuit between a power source and one or more electric or electronic devices.

The bimetal arm 3 is designed so as to keep the fixed and mobile contacts 7, 9 in osculation under normal current conditions in the electric circuit but to drive the contacts 7, 9 out of the osculation on generation of overcurrent in the electric circuit.

At a position somewhat distant from the distal end of the bimetal arm 3, a leaf spring 5 is fixed at its proximal end to the other inner wall 103 of the casing 1. The distal end of the leaf spring 5 is in engagement with the distal end of the bimetal arm 3 in order to urge the bimetal arm 3 to press the mobile contact 9 against the fixed contact 7.

As long as the circuit is in normal current conditions and current flows between the two circuit sections through the circuit breaker, the fixed and mobile contacts 7, 9 are kept in osculation.

On generation of overcurrent in the circuit, the bimetal arm 3 exhibits thermal deformation to drive the contacts 7, 9 out of osculation, thereby the circuit being intercepted.

As the overcurrent disappears, the bimetal type arm 3 resumes its original configuration to restore the osculation of the contacts and the circuit sections are connected via the circuit breaker to connect the power source to the electric or electronic devices.

Although the bimetal arm 3 automatically resumes its original configuration as the overcurrent disappears, the circuit breaker may be provided with a manually operable return button for reliable resumption. More specifically, a radial through hole is formed in the casing 1. A return button 11 is interposed between the casing 1 and the bimetal arm 3 with its head being received in the through hole and its main body being in contact with the bimetal arm 3. A compression coil spring 13 is interposed between the casing 1 and the main body of the return button 11 so as to press the main body of the return button 11 against the bimetal arm 3.

As the bimetal arm exhibits thermal deformation due to generation of overcurrent, the head of the return button 11 projects somewhat outwards via the through hole. So, manual depressing of the return button 11 causes reliable osculation of the two contacts 7 and 9.

A modification of this embodiment is shown in FIG. 2 in which like elements are indicated with like reference numerals. In the case of this modification, the casing 1 is made up of three cylinders axially connected to each other. More specifically, the casing 1 is made up of a center cylinder 113 and two end cylinders 111, 115 axially connected to both longitudinal ends of the center cylinder 113. Preferably, the center cylinder 113 is made of a transparent material such as glass or plastics and the end cylinders 111, 115 are made of metals.

The leaf spring 5 is carried by a support disc 15 fixed to one end cylinder 111. The fixed contact 7 is also arranged in the end cylinder 111. The bimetal arm 3 is carried by the other end cylinder 115. Thus, the bimetal arm 3 and its related parts are visible from outside through the center cylinder 113. When necessary, the three cylinders are disconnected from each other for easy maintenance or inspection of these parts. The real product of the present invention generally has a dimension of about 30 mm length and about 6.4 mm diameter.

Although the foregoing description is directed to a cylindrical casing of a circular cross section, a casing of a square cross section is also employable. In this case, the fixed contact 7 and the bimetal arm 3 are arranged on opposite inner walls of the casing 1.

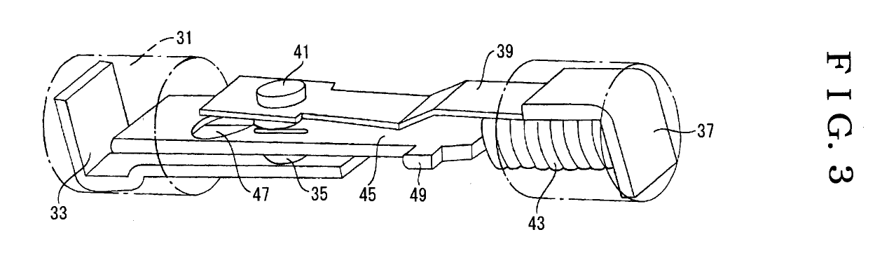

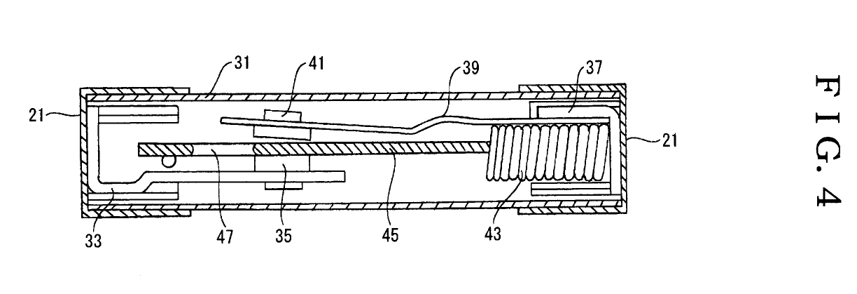

Another embodiment of the circuit breaker in accordance with the present invention is shown in FIGS. 3 and 4 in which all the component of the circuit breaker are accommodated within a cylindrical casing 31. This casing 31 is preferably made of a transparent material such as plastics at least over its center section. The casing 31 is accompanied at its both longitudinal ends with protection caps 21.

The first arm 33 is fixed at its proximal end to the first longitudinal inner end (left side end in the illustration) of the casing 31 and its distal end carries a fixed contact 35 which is connected to the first circuit section not shown.

The second arm 39 made of bimetal is carried via a holder 37 by the second longitudinal inner end of the casing 31 and extends to about the middle longitudinal section of the casing 31. The second arm 39 carries at its distal end a mobile contact 41 which is connected to the second circuit section not shown.

The second arm 39 is constructed such that it keeps the both contacts 35, 41 in osculation under normal current conditions but exhibits thermal deformation on generation of overcurrent to drive the contacts 35, 41 out of the osculation.

A coil type compression spring 43 is carried by the second inner end of the casing 31 at a position adjacent to the second arm 39. A separator 45 is kept at its proximal end in engagement with the compression spring 43 and extends longitudinally in the casing 31 at a position between the first and second arms 33, 39.

The separator 45 is provided at a position corresponding to the contacts 35, 41 with a through hole 47 formed in its thickness direction. The fixed and mobile contacts 35, 41 are in osculation via this through hole 47.

A manual knob 49 is formed on one side face of the separator 45 and a corresponding longitudinal slot not shown is formed through the wall of the casing 31. The knob 49 projects outwards via the slot for manual operation thereon.

As long as the circuit is under normal conditions, the second arm 39 exhibits no thermal deformation and the mobile contact 41 is kept in osculation with the fixed contact 35 via the through hole, 47 in the separator 45. Under these conditions, the separator 45 is urged by the compression spring 43 to be in pressure contact with the mobile contact 41.

On generation of overcurrent, the second arm 39 exhibits thermal deformation and the mobile contact 41 is driven out of osculation with the fixed contact 35, thereby jumping out of the through hole 47 in the separator 45. Then, the separator 45 is urged by the compression spring 43 to move towards the first inner end of the casing 31 so that its unperforated section moves to a position between the both contacts 35 and 41. As a consequence, the two circuit sections are intercepted. Concurrently, the knob 49 on the separator 45 moves in the same direction along the longitudinal slot in the casing 31.

As the overcurrent disappears, the knob 49 is manually returned to its original position against the force of the compression spring 43. Then, the through hole 47 in the separator 45 resumes the position between the two contacts 35 and 41. Since the second arm 39 has resumed the original configuration at this moment, the contacts 35 and 41 are again brought into osculation via the through hole 47 in the separator 45 and the circuit sections are connected.

Since the circuit breaker in accordance with the present invention is reusable after interception of the circuit, it has a significant economic advantage, saves natural resources and minimizes maintenance operations.

What is claimed is

1. A circuit breaker comprising
a hollow cylindrical casing having first and second longitudinal ends,
a fixed contact connected to a first circuit section and arranged in said casing,
a bimetal type arm mounted at one end to said second longitudinal end of said casing,
a mobile contact connected to a second circuit section and mounted to said bimetal type arm opposite to said fixed contact, and
said bimetal arm being designed so as to keep said contacts in osculation under normal current conditions but to drive said contacts out of said osculation on generation of overcurrent.

2. A circuit breaker as claimed in claim 1 in which
said fixed contact is arranged near said first longitudinal end of said casing,
said bimetal arm is fixed at its proximal end to said second longitudinal end of said casing,
said mobile contact is mounted to a distal end of said bimetal arm, and
a leaf spring is fixed at its proximal end to said casing in engagement at its distal end with a distal end of said bimetal arm so as to urge said contacts to said osculation.

3. A circuit breaker as claimed in claim 1 in which
said casing is provided with a longitudinal slit,
said fixed contact is mounted to a distal end of a first arm which is fixed at its proximal end to said first longitudinal end of said casing and extends in a longitudinal direction of said casing,
said bimetal type arm is fixed at its proximal end to said second longitudinal end of said casing,
said mobile contact is mounted to a distal end of said bimetal type arm,
a compression spring is connected to said second longitudinal end of said casing,
a separator engages at its proximal end with said compression spring and extends in a longitudinal direction of said casing at a position between said first and second arms,
said separator is provided with a through hole for osculation of said contacts,
a manual knob is formed on said separator and extends out of said casing through said slit, and
said contacts are kept in osculation under normal current conditions.

4. A circuit breaker as claimed in claim 2 or 3 in which
said casing is made up of a center cylinder and two end cylinders longitudinally and separably connected to said center cylinder, and at least said center cylinder is made of a transparent material.
